(19) United States
(12) Patent Application Publication
(10) Pub. No.: US 2013/0152712 A1
(43) Pub. Date: Jun. 20, 2013

(54) MOTOR ASSEMBLY FOR CAR

(71) Applicant: Hyundai Motor Company, Seoul (KR)

(72) Inventors: Hoo-sang Park, Hwasung-si (KR); Jong-Pil Jung, Choenan-shi (KR)

(73) Assignees: Junyoung Industrial Co., Ltd., Gyeosan-kun (KR); Hyundai Motor Company, Seoul (KR)

(21) Appl. No.: 13/660,727

(22) Filed: Oct. 25, 2012

(30) Foreign Application Priority Data
Dec. 15, 2011 (KR) 10-2011-0135658

(51) Int. Cl. F16H 19/04

(52) U.S. Cl. 74/30

(57) ABSTRACT

A motor assembly for a vehicle may include a brushless DC (BLDC) driving motor received in a case, a pinion fixed to a motor shaft rotatably coupled to the driving motor, a driven wheel rotatably positioned on a base of a holding stack extending from one end of the case, and fixed to a driven wheel shaft rotatably mounted on the base to rotate in engagement with the pinion, and a wire actuating pinion fixed to the driven wheel shaft.

### CROSS-REFERENCE TO RELATED APPLICATIONS

The present application claims priority to Korean Patent Application No. 10-2011-0135658, filed on Dec. 15, 2011, the entire contents of which is incorporated herein for all purposes by this reference.

### BACKGROUND OF THE INVENTION

1. Field of the Invention

The present invention relates to a motor assembly for a car using a brushless DC (BLDC) driving motor, and more particularly, to a motor assembly for a car using a direct driving type BLDC driving motor in which a pinion gear is installed on a driving shaft of the BLDC driving motor and a driven wheel is directly driven on the pinion gear, and as a result, driving efficiency is improved and a durability life-span is extended, and the motor assembly can be used over a long time without a change in characteristic as compared with a motor assembly having a worm shaft structure in the related art and a structure is slimmer to increase an effective value of a car by widely utilizing an internal space of the car.

2. Description of Related Art

A motor assembly for a car in the related art has a structure in which a worm gear 2 is installed at a front end portion of a driving motor 1, a worm wheel 3 is installed to engage with the worm gear 2, a pinion 4 is disposed in a lower part of the worm wheel 3, and the pinion 4 engages with a rack 6 of a wire 5, as shown in FIG. 6, and when the motor 1 is driven, the pinion 4 is driven and the wire 5 is actuated by driving the pinion 4 to actuate a window such as a sun roof.

Since the motor assembly for a car in the related art has the structure in which the worm wheel 3 engages with the worm gear 2, friction heat is generated between the worm gear 2 and the worm wheel 3, such that efficiency of the driving motor 1 deteriorates and the worm gear 2 which extends in a longitudinal direction by the structure in which the worm gear 2 and the worm wheel 3 engage with each other may deteriorate axially, thereby deteriorating efficiency and durability.

Further, since a gear ratio between the worm gear 2 and the worm wheel 3 is large, abrasion becomes serious while the resulting friction force becomes large and the durability life-span may deteriorate.

In addition, when the motor assembly for a car is dropped due to a worker's carelessness during installation or repairing, there is a risk that components of the motor will be damaged due to a large length of the driving motor 1 and components which are vulnerable to impact resistance, such as a brush.

Moreover, when the motor assembly for a car in the related art is mounted on the sun roof, a controller and a cover are disposed on the bottom of the worm wheel 3 and internal and external materials of the car are attached between the motor assemblies for the car, and as a result, when the motor assembly in the related art is installed in the sun roof, an installation height increases, such that the internal space is reduced as large, thereby reducing utilization of an indoor space of the car.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a motor assembly for a car using a BLDC motor in which an actuated door of the car is configured to be directly driven in a pinion connected with the driving motor, such that driving efficiency is improved, a durability life-span is extended, and the motor assembly can be used in the long term without a change in characteristic as compared with a worm gear structure in the related art, the motor assembly is installed to be slim to increase an internal space of the car and a volume is small and durability is high, and driving force is large and silence is strengthened.

In an aspect of the present invention, a motor assembly for a vehicle, may may include a brushless DC (BLDC) driving motor received in a case, a pinion fixed to a motor shaft rotatably coupled to the driving motor, a driven wheel rotatably positioned on a base of a holding stack extending from one end of the case, and fixed to a driven wheel shaft rotatably mounted on the base to rotate in engagement with the pinion, and a wire actuating pinion fixed to the driven wheel shaft.

The pinion and the driven wheel are spur gears.

Bearing are installed below the pinion and the wire actuating pinion, respectively.

One of the bearings is installed between the BLDC driving motor and the pinion and the other of the bearings is installed between the driven wheel and the wire actuating pinion.

The motor assembly for the vehicle may further may include a cover coupled to the case.

The wire actuating pinion drives a wire that moves forward and backward a sun roof glass.

The wire actuating pinion drives a wire that moves up and down a door glass of the vehicle.

The motor assembly for a car according to the exemplary embodiment of the present invention having the above configuration provides the following effects.

First, by adopting a BLDC motor as a driving motor, a change in characteristic is not large as a ball bearing type in terms of the characteristic, such that driving stability is excellent and noise is low.

Second, since the BLDC driving motor and the pinion gear are coupled to each other in a direct driving method, friction heat by the driving motor is smaller than a worm structure in the related art to improve efficiency of the driving motor and remarkably decreases inter-shaft deformability of the driving motor, thereby increasing durability of the motor assembly.

Third, since the pinion gear, the driven wheel and the wire actuating pinion gear of the BLDC driving motor are integrally coupled to each other, the driving motor and the gear part are integrally formed, and as a result, mechanical deformability is low, and since the length of the shaft is small, the shaft bending or deforming failure does not occur, and power transfer efficiency is improved by 20% or more as compared with the worm gear structure in the related art.

Fourth, since the motor assembly can be easily installed in even a small space due to a low profile and a small form factor, utilization of an indoor space of a car can be increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a motor assembly according to an exemplary embodiment of the present invention.

FIG. 2 is a detailed diagram of a driving motor and a driven wheel of the motor assembly according to the exemplary embodiment of the present invention.

FIG. 3 is an exploded perspective view of the driving motor of the motor assembly according to the exemplary embodiment of the present invention.

FIG. 4 is a side view of the motor assembly according to the exemplary embodiment of the present invention.

FIG. 5 is a diagram showing a state in which a cover is assembled to the motor assembly according to the exemplary embodiment of the present invention.

FIG. 6 is a perspective view showing a configuration of a motor assembly in the related art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a configuration of a motor assembly for a car according to an exemplary embodiment of the present invention will be described in detail with reference to the accompanying drawings.

However, illustrated drawings are provided as examples to sufficiently transfer the spirit of the present invention to those skilled in the art. Accordingly, the present invention is not limited to the presented drawings but may be implemented by other aspects.

Terms used in the specification of the present invention have meanings which are generally understood by those skilled in the art if the terms are particularly defined and detailed descriptions of known functions and configurations which may obscure the spirit of the present invention will be omitted in the following description and the accompanying drawings.

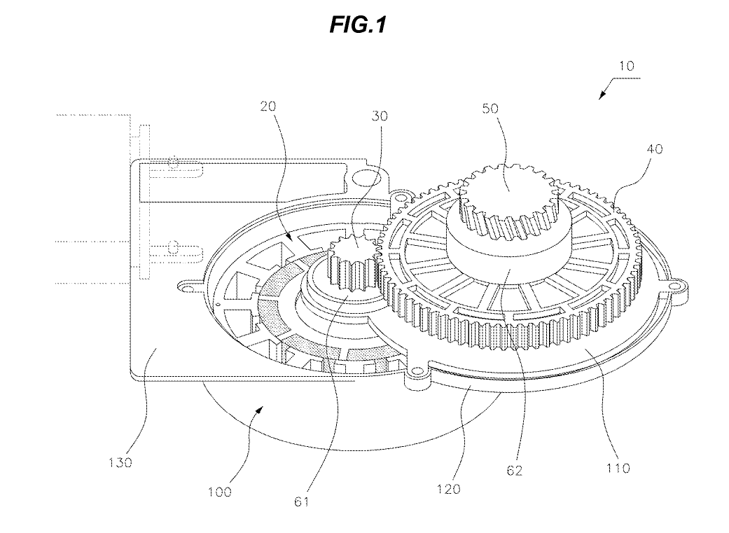

FIG. 1 is a perspective view of a motor assembly for a car according to an exemplary embodiment of the present invention.

The motor assembly 10 according to the exemplary embodiment of the present invention adopts a brushless DC (BLDC) driving motor 20 without a brush as a driving motor, in which a worm gear and a worm wheel are changed to a direct driving method of a pinion gear 30 and a driven wheel 40, in order to emerge from a structure in which the worm wheel engages with the worm gear in the aforementioned motor assembly for a car in the related art.

As shown in FIG. 1, the motor assembly 10 for a car according to the exemplary embodiment of the present invention includes a BLDC driving motor 20 received at the center of a case 100, a pinion 30 attached and fixed to one end portion of a motor shaft 24 of the driving motor 20, a driven wheel 40 positioned on a base 110 of a circular plate-like holding stack 120 that extends to one end of the case 100 and coupled to a driven wheel shaft 51 formed at the center of the base 110 to rotate in engagement with the pinion 30, and a wire actuating pinion 50 attached and fixed to one end portion of the driven wheel shaft 51.

The BLDC driving motor 20 as a known DC motor without a commutator and a brush adopts a hall sensor as a position detecting device of a rotor 22 instead of the brush.

Accordingly, since the BLDC driving motor 20 adopted in the exemplary embodiment of the present invention does not have the brush, there are no spark and noise generated from the brush, and as a result, high-speed driving can be achieved, and since the BLDC driving motor 20 does not have the commutator and the brush, miniaturization can be achieved.

The BLDC driving motor 20 may be thinned according to a design method thereof and a general DC motor has a limit in commutation, but the BLDC driving motor 20 has no limit in commutation, and as a result, instant allowable maximum torque may be designed to be large and a large amount of heat is generated from a rotor side of the general DC driving motor, but heat is generated from only a stator 21 of the BLDC driving motor 20, and as a result, heat is easily dissipated.

In the case where the BLDC driving motor 20 is dropped or impact is given to the BLDC driving motor 20 during working, known damage of the brush motor such as the damage of the commutator or brush does not occur. Therefore, a probability that the BLDC driving motor will be damaged is low, and it is easy to maintain and repair the BDLC driving motor 20.

Since output torque to input current is proportional linearly, the BLDC driving motor 20 is excellent even in output efficiency.

Meanwhile, a flange 130 for coupling with a cover 140 to be described below is formed on the other end of the case 100.

Bearings 61 and 62 are installed below the pinion 30 and the wire actuating pinion 50, respectively, and the bearings 61 and 62 are coupled onto the motor shaft 24 and the driven wheel shaft 51, respectively. As the bearings 61 and 62, general bearings are used.

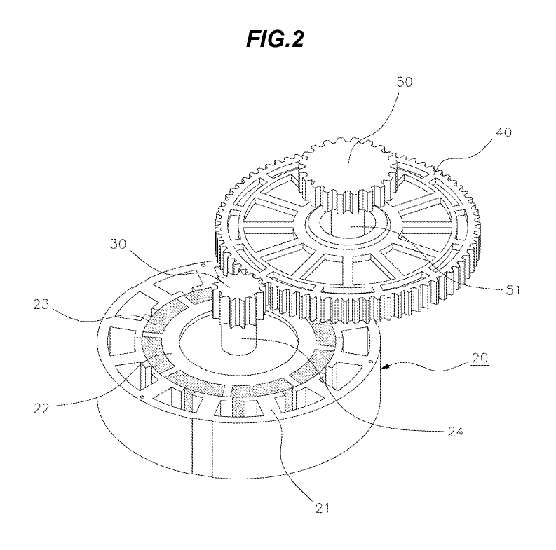

FIG. 2 is a detailed diagram of a driving motor and a driven wheel of the motor assembly according to the exemplary embodiment of the present invention.

As shown in the figure, the pinion 30 is attached and fixed to the motor shaft 24 of the BLDC driving motor 20 and the pinion 30 and the driven wheel 40 engage with each other, and as a result, the driving motor 20 and the wire actuating pinion 50 installed in the driven wheel shaft 51 are coupled with each other in an inter-direct driving method.

That is, the pinion 30 is installed on the motor shaft 24, such that power transfer to and from the driven wheel 40 that engages with the pinion 30 is smoothly executed to remarkably reduce abrasion of the pinion 30 and the driven wheel 40, and as a result, a durability life-span extends and friction heat due to the power transfer is decreased, such that driving efficiency increases by 20% as compared with the related art, and as a result, power consumption is saved together.

Since the pinion 30 is fixed to an end portion of the motor shaft 24, the motor shaft 24 is not deformed, such that long-term use can also be achieved.

The direct-driving type motor assembly 10 for a car of the present invention has a height of approximately 5 cm and thus has a smaller height than the motor assembly for a car in the related art which has a height of 7 cm, thereby ensuring an indoor space of the car as large as a height difference.

The wire actuating pinion 50 is a pinion for actuating the wire 5 which moves forward and backward sun roof glass while rotating along the driven wheel 50 that rotates by the rotation of the pinion 30.

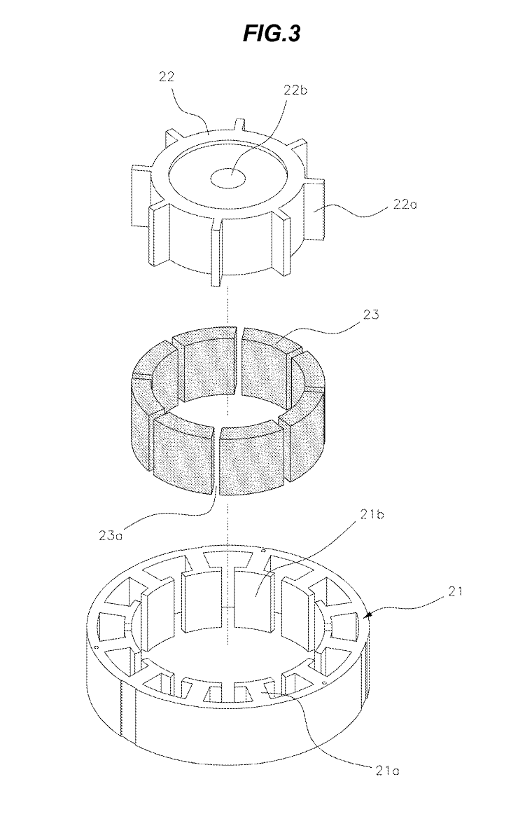

As shown in FIG. 3, the BLDC motor 20 includes the stator 21 formed outside the BLDC motor 20 and the rotor 22 installed in the stator 21 and a magnet 23 is interposed between the stator 21 and the rotor 22.

In this case, a plurality of supporters 21a that protrude inside the stator 21 and have a supporting surface 21b at a terminal are formed radially and the rotor 22 is inserted inside the supporting surface 21b.

A shaft hole 22b coupled with the motor shaft 24 is formed at the center of the rotor 22, a plurality of protruding pieces 22a that protrude radially are provided on an outer peripheral surface thereof, and the protruding pieces 22a contact the supporting surface 21b of the stator 21.

A plurality of magnets 23 are inserted into a space between the supporting surface 21 b of the stator 21 and the protruding piece 22a of the rotor 22 by a predetermined clearance 23a.

In the BLDC motor 20 according to the exemplary embodiment of the present invention configured as above, DC power is converted into three phases to be supplied to the motor and the phases are changed by sensing the position of the magnet 23 by means of voltage supplied to the stator 21 to rotate the rotor 22 and a hall sensor for sensing the position of the magnet 23 is incorporated.

Since an operational principle of the BLDC motor 20 is known, a detailed description thereof will be omitted.

Hereinafter, an operation of the motor assembly 10 for a car according to the exemplary embodiment of the present invention having the above configuration will be described.

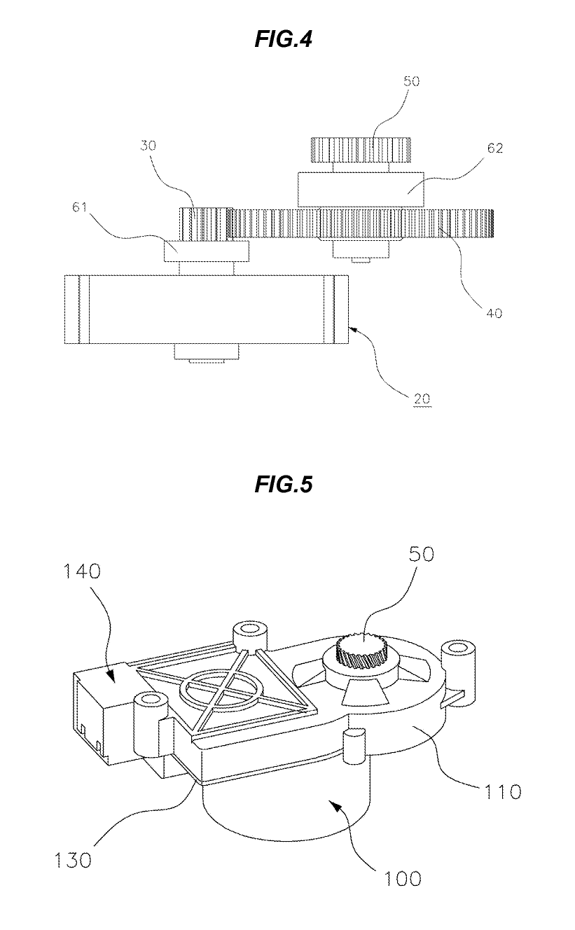

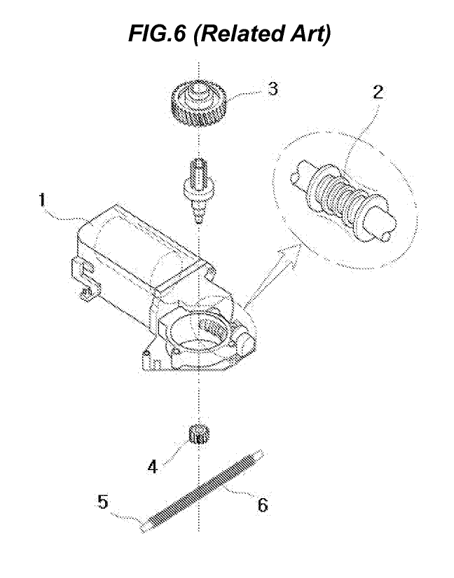

As shown in the perspective view of FIG. 2 and the side view of FIG. 4, when power is applied to the BLDC driving motor 20 to rotate the motor 20, the pinion 30 attached and fixed to the motor shaft 24 of the motor 20 rotates and the rotation of the pinion 30 is directly transferred to the driven wheel 40 that engages with the pinion 30 to rotate even the driven wheel 40 in the direct driving method.

The driven wheel 40 is used to acquire large driving force by decelerating the rotational force of the driving motor 20. The wire actuating pinion 50 installed at the center of the driven wheel 40 is actuated by the rotation of the driven wheel 40. The wire actuating pinion 50 actuated as above drives the wire 5 of a sun roof as shown in FIG. 1 to actuate the sun roof or may also drive a wire that moves up and down door glass of a car.

When the motor assembly 10 according to the exemplary embodiment of the present invention is actually mounted on a sun roof driver, the cover 140 coupled to the holding stack 110 part and the flange 130 part of the case 100 is coupled to the motor assembly 10, which is used, as shown in FIG. 5.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A motor assembly for a vehicle, comprising:
a brushless DC (BLDC) driving motor received in a case;
a pinion fixed to a motor shaft rotatably coupled to the driving motor;
a driven wheel rotatably positioned on a base of a holding stack extending from one end of the case, and fixed to a driven wheel shaft rotatably mounted on the base to rotate in engagement with the pinion; and
a wire actuating pinion fixed to the driven wheel shaft.

2. The motor assembly for the vehicle of claim 1, wherein the pinion and the driven wheel are spur gears.

3. The motor assembly for the vehicle of claim 1, wherein bearings are installed below the pinion and the wire actuating pinion, respectively.

4. The motor assembly for the vehicle of claim 3, wherein one of the bearings is installed between the BLDC driving motor and the pinion and the other of the bearings is installed between the driven wheel and the wire actuating pinion.

5. The motor assembly for the vehicle of claim 1, further including a cover coupled to the case.

6. The motor assembly for the vehicle of claim 1, wherein the wire actuating pinion drives a wire that moves forward and backward a sun roof glass.

7. The motor assembly for the vehicle of claim 1, wherein the wire actuating pinion drives a wire that moves up and down a door glass of the vehicle.
